(19) United States
(12) Patent Application Publication
(10) Pub. No.: US 2005/0201633 A1
(43) Pub. Date: Sep. 15, 2005

(54) Method, medium, and filter removing a blocking effect

(75) Inventors: Joo-hee Moon, Seoul (KR); Sun-young Park, Seoul (KR)

Correspondence Address: STAAS & HALSEY LLP, SUITE 700, 1201 NEW YORK AVENUE, N.W., WASHINGTON, DC, 20005, US

(73) Assignees: Daeyang Foundation, Seoul (KR); Samsung Electronics Co., Ltd., Suwon-si (KR)

(21) Appl. No.: 11/077,332

(22) Filed: Mar. 11, 2005

(30) Foreign Application Priority Data
Mar. 11, 2004 (KR) 10-2004-0016619

(51) Int. Cl. G06K 9/40; G06K 9/36

(52) U.S. Cl. 382/268; 382/236

(57) ABSTRACT

Provided are a method, medium, and filter for removing discontinuity of an image. The filtering method includes determining the direction or gradient on a boundary of a block of an image divided into blocks of a predetermined size, based on pixel distribution between adjacent blocks and filtering the blocks based on the determined direction or gradient.

### BACKGROUND OF THE INVENTION

This application claims the benefit of Korean Patent Application No. 10-2004-0016619, filed on Mar. 11, 2004, in the Korean Intellectual Property Office, the disclosure of which is incorporated herein in its entirety by reference.

1. Field of the Invention

Embodiments of the present invention relate to encoding and decoding of motion picture data, and, more particularly, to a method, medium, and filter for removing a blocking effect.

2. Description of the Related Art

Encoding picture data is necessary for transmitting images via a network having a fixed bandwidth or for storing images in storage media. A great amount of research has been conducted for the effective transmission and storage of images. Among various image encoding methods, transform-based encoding is most widely used, while discrete cosine transform (DCT) is widely used in the field of transform-based image encoding.

Among a variety of image encoding standards, H.264 AVC standards apply integer DCT to intraprediction and interprediction to obtain a high compression rate and encode a difference between a predicted image and an original image. Since information of less importance among DCT coefficients is discarded after the completion of DCT and quantization, the quality of an image decoded through an inverse transform is degraded. In other words, while a transmission bit rate for image data is reduced due to compression, image quality is degraded. DCT is carried out in block units of a predetermined size into which an image is divided. Since transform coding is performed in block units, a blocking effect arises where discontinuity occurs at boundaries between blocks.

Also, motion compensation in block units causes a blocking effect. Motion information of a current block, which can be used for image decoding, is limited to one motion vector per block of a predetermined size within a frame, e.g., per macroblock. A predictive motion vector (PMV) is subtracted from an actual motion vector, and then the actual motion vector is encoded. The PMV is obtained using a motion vector of the current block and a motion vector of a block adjacent to the current block.

Motion-compensated blocks are created by copying interpolated pixel values from blocks of different locations in previous reference frames. As a result, pixel values of blocks are significantly different and a discontinuity occurs on the boundaries between blocks. Moreover, during copying, a discontinuity between blocks in a reference frame is intactly delivered to a block to be compensated for. Thus, even when a 4×4 block is used in H.264 AVC, filtering should be performed on a decoded image to remove any discontinuity across block boundaries.

As described above, a blocking effect arises due to an error caused during transform and quantization on a block basis and is a type of image quality degradation, where discontinuity on the block boundary occurs regularly like laid tiles as a compression rate increases. To remove such discontinuity, filters are used. The filters are classified into post filters and loop filters.

Post filters are located on the rear portions of encoders and can be designed independently of decoders. On the other hand, loop filters are located inside encoders and perform filtering during the encoding process. In other words, filtered frames are used as reference frames for motion compensation of frames to be encoded next.

Various methods have been studied to reduce the blocking effect and post filtering methods, as one of them, include the following schemes. One is to overlap adjacent blocks, so that they can have a proper degree of correlation when encoded. Another is to perform low pass filtering on pixels located on the block boundary based on the fact that the visibility of the blocking effect is caused by a high spatial frequency of a discontinuous portion of a block.

Filtering by loop filters inside encoders is advantageous over post filters in some respects. First, by including loop filters inside of encoders, a proper degree of image quality can be guaranteed. In other words, it is possible to ensure superior image quality in the manufacturing of contents by removing the blocking effect. Secondly, there is no need for an extra frame buffer in decoders. Namely, since filtering is performed in macroblock units during decoding and filtered frames are directly stored in a reference frame buffer, an extra frame buffer is not required. Thirdly, when using a post filter, a structure of a decoder is simpler, and subjective and objective results of video streams are superior.

However, conventional loop filters cannot completely remove the blocking effect because they are not based on the direction between blocks.

### SUMMARY OF THE INVENTION

Embodiments of the present invention provide a method, medium, and filter for removing any discontinuity based on the direction or gradient between blocks during the encoding and decoding of images.

Additional aspects and/or advantages of the invention will be set forth in part in the description which follows and, in part, will be obvious from the description, or may be learned by practice of the invention.

According to an aspect of the present invention, there is provided a filtering method including: determining a direction or a gradient on a boundary of a block of an image divided into blocks of a predetermined size, based on pixel distribution between adjacent blocks; and filtering the blocks based on the determined direction or gradient or discretion.

According to another aspect of the present invention, there is provided a filtering method which removes any discontinuity on boundaries between blocks of a predetermined size in an image composed of the blocks. The filtering method includes: determining a direction of a discontinuity on a boundary of a block based on a difference in pixel values between a pixel on the boundary of the block and a pixel on a boundary of an adjacent block of the block; and filtering the block using different selected pixels, based on the determined direction or gradient.

According to an aspect of the present invention, the adjacent block is located to the left-side and upside from the block.

Preferably, the determining comprises calculating a sum of differences in pixel value between the pixel on the boundary of the block to be filtered and the pixel on the boundary of the adjacent block, in the horizontal, the vertical, and the diagonal directions and determining a direction to be the direction of discontinuity on the boundary of the block to be filtered.

According to an aspect of the present invention, 4 pixels of an adjacent block and 4 pixels of the block are selected according to the determined direction in the horizontal, the vertical, or the diagonal direction to filter the block.

According to yet another aspect of the present invention, there is provided a filter which removes any discontinuity on boundaries between blocks of a predetermined size in an image composed of the blocks. The filter includes a direction determining unit that determines the direction of a discontinuity on a boundary of a block of an image divided into blocks of a predetermined size, based on pixel distribution between adjacent blocks and a filtering unit that filters the blocks based on the determined direction.

According to an aspect of the present invention, the direction determining unit calculates a sum of differences in pixel value between the pixel on the boundary of the block and the pixel on the boundary of the adjacent block, in the horizontal, the vertical, and the diagonal directions and determines a direction to be the direction of discontinuity on the boundary of the block.

According to an aspect of the present invention, the filtering unit selects 4 pixels of adjacent block and 4 pixels of the block to be filtered according to the determined direction in the horizontal, the vertical, or the diagonal direction to filter the block.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a block diagram of an encoder according to a preferred embodiment of the present invention;

FIG. 2 illustrates directions of 9 prediction modes in an intra 4×4 mode;

FIG. 3 illustrates variable blocks that can be owned by a macroblock in interprediction;

FIG. 4 illustrates multiple reference pictures used for motion estimation;

FIG. 5A shows boundary pixels filtered with respect to a luminance block and a filtering order;

FIG. 5B shows boundary pixels filtered with respect to a chrominance block and a filtering order;

FIGS. 6A and 6B show pixels used for filtering;

FIG. 7 shows boundary pixels of blocks adjacent to a current block for explaining directivity-based filtering according to the present invention;

FIGS. 8A and 8B are views for explaining calculation of a difference between pixel values of two pixels;

FIG. 9 shows pixel values used when filtering is performed based on the directivity;

FIG. 10 is a block diagram of a filter for removing a blocking effect according to the present invention; and

FIG. 11 shows a boundary portion between blocks.

### DETAILED DESCRIPTION OF THE INVENTION

Reference will now be made in detail to the embodiments of the present invention, examples of which are illustrated in the accompanying drawings, wherein like reference numerals refer to the like elements throughout. The embodiments are described below to explain the present invention by referring to the figures.

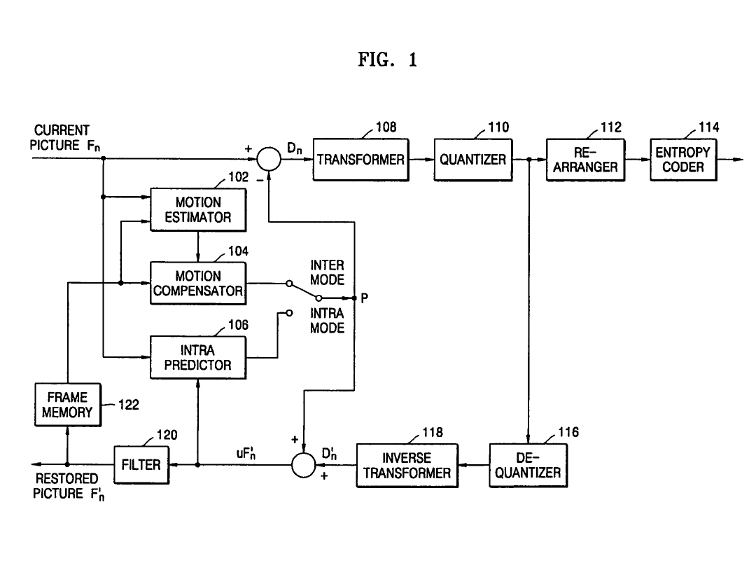

FIG. 1 is a block diagram of an encoder according to a preferred embodiment of the present invention.

The encoder includes a motion estimator unit 102, a motion compensator 104, an intra predictor 106, a transformer 108, a quantizer 110, a re-arranger 112, an entropy coder 114, a de-quantizer 116, an inverse transformer 118, a filter 120, and a frame memory 122.

The encoder encodes macroblocks of a current block in an encoding mode selected among various encoding modes. To encode video, a picture is divided into several macroblocks. After encoding the macroblocks in all the encoding modes of interprediction and all the encoding modes of intraprediction, the encoder selects one encoding mode according to a bit rate required for encoding of the macroblocks and the degree of distortion between the original macroblocks and decoded macroblocks and performs encoding in the selected encoding mode.

Inter mode is used in interprediction where a difference between the motion vector information indicating a location of one macroblock selected from a reference picture or locations of a plurality of macroblocks selected from a reference picture and a pixel value is encoded in order to encode macroblocks of a current picture. Since H.264 offers a maximum of 5 reference pictures, a reference picture to be referred to by a current macroblock is searched in a frame memory that stores reference pictures. The reference pictures stored in the frame memory may be previously encoded pictures or pictures to be used.

Intra mode is used in intraprediction where a predicted value of a macroblock to be encoded is calculated using a pixel value of a pixel that is spatially adjacent to the macroblock to be encoded and a difference between the predicted value and the pixel value is encoded, instead of referring to reference pictures, in order to encode the macroblocks of the current picture.

There exist a large number of modes depending on how to divide an image in inter mode. Similarly, there exist numerous modes depending on the direction of the prediction in intra mode. Thus, selecting the optimal mode among these modes is a very important task that affects the performance of image encoding. To this end, generally, rate-distortion (RD) costs in all the possible modes are calculated, a mode having the smallest RD costs is selected as the optimal mode, and encoding is performed in the selected mode. As a result, a lot of time and costs are required for image encoding.

The encoder according to an embodiment of the present invention performs encoding in all the modes interprediction and intraprediction can have, calculates RD costs, selects a mode having the smallest RD costs as the optimal mode, and performs encoding in the selected mode.

For interprediction, the motion compensator 102 searches for a predicted value of a macroblock of a current picture in reference pictures. If a reference block is found in ½ or ¼ pixel units, the motion compensator 104 calculates an intermediate pixel value of the reference block to determine a reference block data value. As such, interprediction is performed by the motion estimator 102 and the motion compensator 104.

Also, the intra predictor 106 performs intraprediction where the predicted value of the macroblock of the current picture is searched within the current picture. A decision whether to perform interprediction or intraprediction on a current macroblock is made by calculating RD costs in all the encoding modes and selecting a mode having the smallest RD cost as an encoding mode of the current macroblock. Encoding is then performed on the current macroblock in the selected encoding mode.

As described above, if predicted data to be referred to by a macroblock of a current frame is obtained through an interprediction or intraprediction, the predicted data is subtracted from the macroblock of the current picture. The transformer 108 performs transform on the resulting macroblock of the current picture and the quantizer 110 quantizes the transform macroblock. The macroblock of the current picture that undergoes a subtraction of a motion estimated reference block is called a residual that is encoded to reduce the amount of data in encoding. A quantized residual is processed by the re-arranger 112 for encoding by the entropy coder 114.

To obtain a reference picture to be used in interprediction, the current picture is restored by processing a quantized picture by the de-quantizer 116 and the inverse transformer 118. The restored current picture is stored in the frame memory 122, and is then used to perform an interprediction on a picture that follows the current picture. If the restored picture passes through the filter 120, it becomes the original picture that additionally includes several encoding errors.

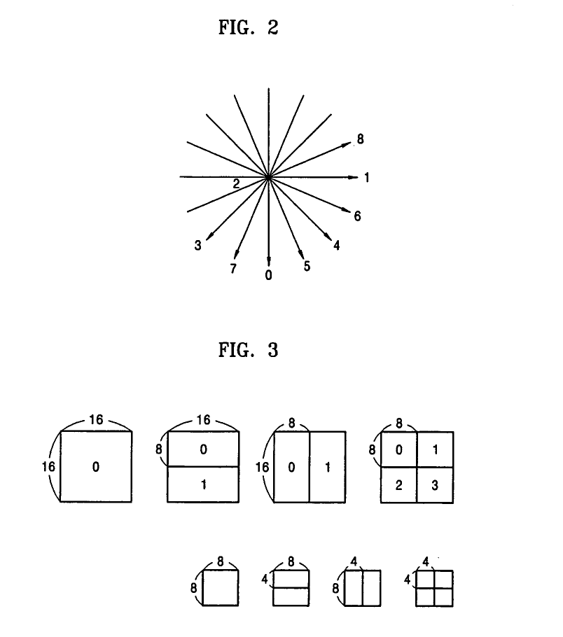

FIG. 2 illustrates directions of 9 prediction modes in intra 4×4 mode.

It can be seen from FIG. 2 that a prediction is performed on blocks in the vertical, horizontal, and diagonal directions, each of which is represented by a mode name. In other words, intra 4×4 mode includes a vertical mode, a horizontal mode, a DC mode, a diagonal_down_left mode, a diagonal_down_right mode, a vertical_right mode, a horizontal_down mode, a vertical_left mode, and a horizontal_up mode.

In addition to the intra 4×4 mode, there exists an intra 16×16 mode. The intra 16×16 mode is used in the case of a uniform image and there are four modes in the intra 16×16 mode.

FIG. 3 illustrates variable blocks that can be owned by a macroblock in an interprediction.

In an interprediction according to H.264, one 16×16 macroblock may be divided into 16×16, 16×8, 8×16, or 8×8 blocks. Each 8×8 block may be divided into 8×4, 4×8, or 4×4 sub-blocks. Motion estimations and compensations are performed on each sub-block, and thus a motion vector is determined. By performing an interprediction using various kinds of variable blocks, it is possible to effectively perform an encoding according to the properties and motion of an image.

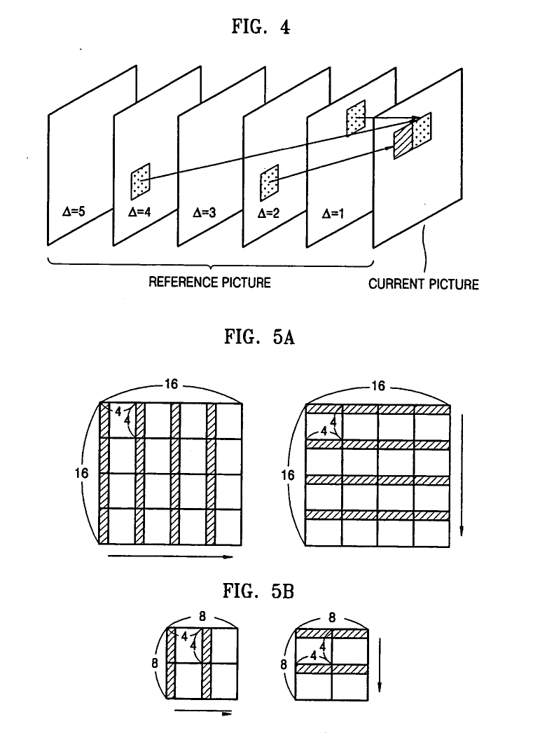

FIG. 4 illustrates multiple reference pictures used for motion estimation.

H.264 AVC performs a motion prediction using multiple reference pictures. In other words, at least one reference picture that is previously encoded can be used as a reference picture for motion prediction. Referring to FIG. 4, to find a macroblock that is most similar to a macroblock of a current picture, a maximum of 5 pictures are searched. These reference pictures all should be stored in both an encoder and a decoder.

Hereinafter, filtering performed by the filter 120 of FIG. 1 will be described in detail.

The filter 120 is a deblocking filter and can perform filtering on boundary pixels of M×N blocks. Hereinafter, it is assumed that M×N blocks are 4×4 blocks. Filtering is performed in macroblock units, and all the macroblocks within a picture are sequentially processed. To perform filtering with respect to each macroblock, pixel values of upper and left filtered blocks adjacent to a current macroblock are used. Filtering is performed separately for luminance and chrominance components.

FIG. 5A shows boundary pixels filtered with respect to a luminance block and a filtering order.

In each macroblock, filtering is first performed on the vertical boundary pixels of a macroblock. The vertical boundary pixels are filtered from left to right as indicated by an arrow in the left side of FIG. 5A. Then, filtering is performed on the horizontal boundary pixels based on a result of filtering the vertical boundary pixels. The horizontal boundary pixels are filtered in an up to down direction as indicated by an arrow in the right side of FIG. 5A. Since filtering is performed in macroblock units, filtering for removing any discontinuity of luminance is performed on 4 lines composed of 16 pixels.

FIG. 5B shows boundary pixels filtered with respect to a chrominance block and a filtering order.

Since the chrominance block has a size of 4×4 that is ¼ of the luminance block, filtering of chrominance components is performed on 2 lines composed of 8 pixels.

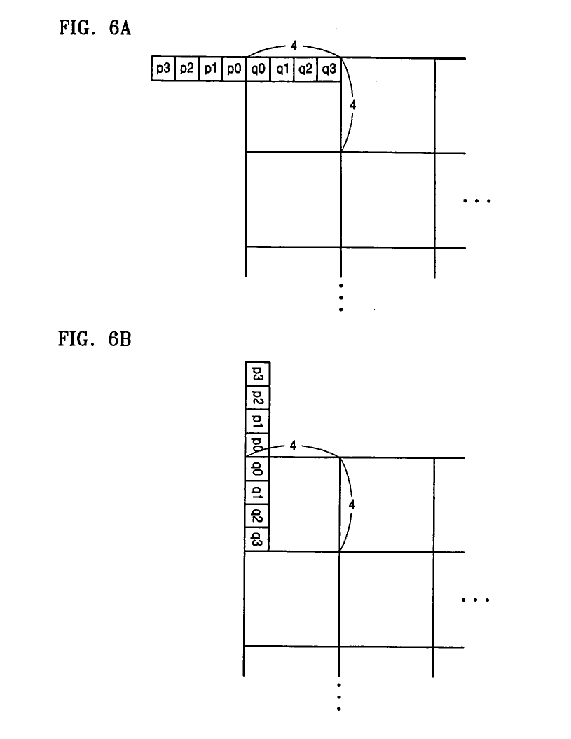

FIGS. 6A and 6B show pixels used for filtering.

Pixels are determined based on a 4×4 block boundary, changed pixel values are calculated using filtering equations indicated below, and pixel values p0, p1, p2, q0, q1, and q2 are mainly changed. Filtering of not only luminance components but also chrominance components is performed in an order similar to that used in the luminance block.

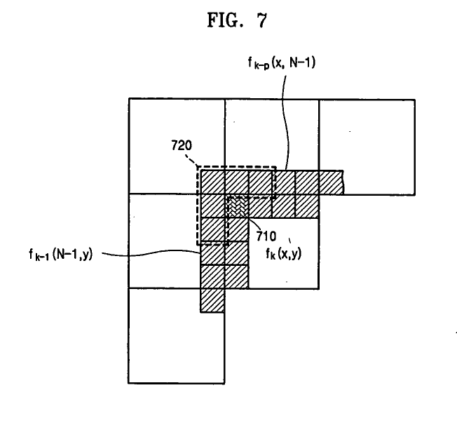

FIG. 7 shows boundary pixels of blocks adjacent to a current block for explaining direction or gradient-based filtering according to an aspect of the present invention.

Direction-based filtering according to an aspect of the present invention is performed on pixels located on all the 4×4 block boundaries, using pixel values in a picture that is already decoded in macroblock units, in a method similar to deblocking filtering of H.264 AVC. However, unlike deblocking filtering of H.264 AVC that is performed on each block boundary only in the vertical and/or horizontal directions, direction-based filtering according to an aspect of the present invention searches for direction in the diagonal direction as well as in the vertical and/or horizontal directions of each 4×4 block and is performed in the found direction. A search for direction of a 4×4 block is done using pixels located on the boundaries of upper and left two blocks that are adjacent to a current block in a spatial domain. If a block size is N×N, a boundary pixel of a k^{th} current block is represented by fₖ (x, y), right boundary pixels of a left-side adjacent block of the k^{th} current block are represented by fₖ₋₁ (N-1, y), and lower boundary pixels of an upper adjacent block of the kth current block are represented by fₖ₋ₚ (x, y). Here, p denotes one period. For example, if a 176×144 image is divided into 16×16 blocks, there are 11 blocks in a row and 9 blocks in a column. In this case, p is equal to 11. Then, fₖ₋₁₁ (x, y) becomes an immediately upper pixel of fₖ (x, y).

Here, x and y move pixel by pixel, and pixels used in filtering pixels located on the boundaries are marked with hatched lines. To detect the diagonal direction three pixel values of an adjacent block are used. For example, adjacent pixels (720) are used to detect direction of a pixel 1 (710).

Referring to FIG. 7, the denominations of detected direction are three: a vertical/horizontal direction a diagonal right-up direction; and a diagonal right-down direction.

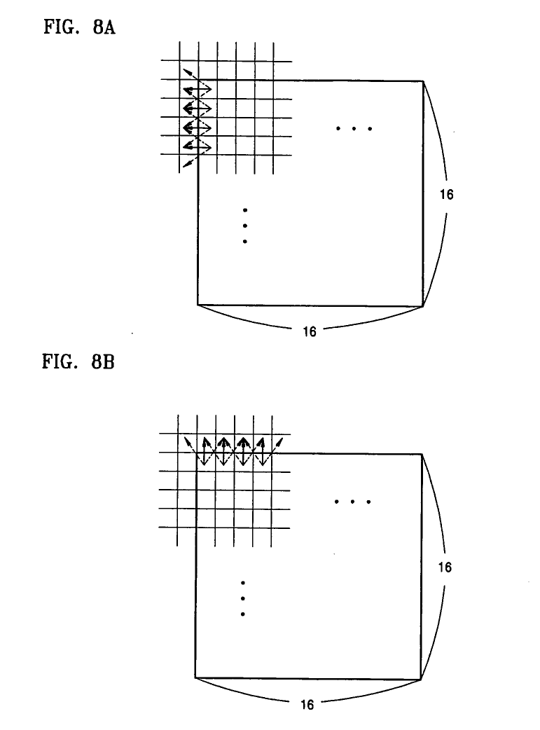

FIGS. 8A and 8B are views for explaining the calculation of a difference between pixel values of two pixels.

FIG. 8A is a view for explaining a detection of the directivity of vertical boundary pixels with respect to the vertical direction and FIG. 8B is a view for explaining the detection of the directivity of horizontal boundary pixels with respect to the horizontal direction. To calculate a difference between the pixel values of two pixels, let a square be one pixel and let an arrow be the directivity. In the present invention, the diagonal direction is added to the vertical/horizontal directions used in H.264 AVC. By performing filtering using pixel values that are similar to those of a current block when the discontinuities between blocks have diagonal directivity, it is possible to prevent averaging in comparison to when filtering is performed using different pixel values. That is, it is possible to have smooth boundaries.

Directivity detection includes the following stages:

\mathring{1} Calculating a Difference Between Pixels:

Pixel values located on a vertical boundary of a block are sequentially filtered using 4×4 blocks that are located to the left side of a current block. Vₖ, RDVₖ, and RUVₖ, which denote the three directions from an origin, i.e., a top-left point of a k^{th} block, are calculated as follows.

$${V}_{k} = {\sum }_{y = 0}^{N - 1} \vert {f}_{k - 1} ( N - 1 , y ) - {f}_{k} ( 0 , y ) \vert \\ {RDV}_{k} = {\sum }_{y = 0}^{N - 1} \vert {f}_{k - 1} ( N - 1 , y - 1 ) - {f}_{k} ( 0 , y ) \vert \\ {RUV}_{k} = {\sum }_{y = 0}^{N - 1} \vert {f}_{k - 1} ( N - 1 , y + 1 ) - {f}_{k} ( 0 , y ) \vert \qquad ( 1 )$$

An image that is decoded and input to a filter is represented by a function f(x, y). To know the direction or gradient, absolute values of the differences between pixel values that are located on boundaries between adjacent blocks in respective directions or gradients are calculated. A block size is N×N. In this embodiment, N is 4.

Also, when pixels on the horizontal boundary of a block are filtered vertically using 4×4 blocks located up from the current block, a difference between the pixel values is calculated as follows. Like the calculation of a difference between pixels located on the vertical boundary, a difference between the pixels located on the horizontal boundary is calculated on a pixel-by-pixel basis from an origin, i.e., a top-left point of the kth block.

$${H}_{k} = {\sum }_{x = 0}^{N - 1} \vert {f}_{k + p} ( x , N - 1 ) - {f}_{k} ( x , 0 ) \vert \\ {RDH}_{k} = {\sum }_{x = 0}^{N - 1} \vert {f}_{k + p} ( x - 1 , N - 1 ) - {f}_{k} ( x , 0 ) \vert \\ {RUH}_{k} = {\sum }_{x = 0}^{N - 1} \vert {f}_{k + p} ( x + 1 , N - 1 ) - {f}_{k} ( x , 0 ) \vert \qquad ( 2 )$$

\mathring{2} Calculating the Minimum Value:

After a difference between the pixel values is calculated in each direction in operation \mathring{1}, the minimum value among the three differences is searched as follows:
DVₖ=min(Vₖ, RDVₖ, RUVₖ) or
DHₖ=min(Hₖ, RDHₖ, RUHₖ) (3)

The direction of the minimum value is determined to be the direction of the pixels located on boundaries between adjacent blocks. Pixels located on the vertical boundary and pixels located on the horizontal boundary are respectively filtered in the determined direction. Hereinafter, filtering will be described.

\mathring{3} Filtering:

Once the direction is determined on the vertical/horizontal boundaries of a current block, filtering is performed based on the determined direction.

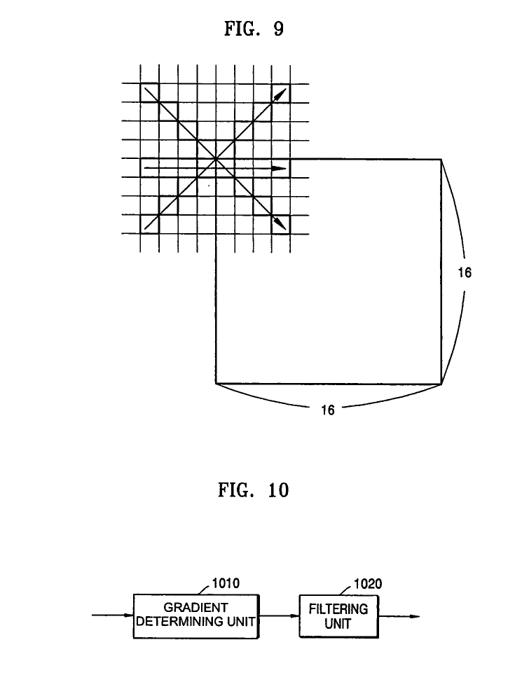

FIG. 9 shows pixel values used when filtering is performed based on the directivity or gradient.

Pixels used for filtering a boundary of a block can be seen from FIG. 9. In other words, it can be seen that when vertical boundary pixels in the horizontal direction are filtered, not only pixels in the horizontal direction but also pixels in the diagonal direction can be selected and filtered according to the determined direction.

FIG. 10 is a block diagram of a filter for removing a blocking effect.

A directivity or gradient determining unit 1010 calculates the direction of a discontinuity on the boundary between a current block and an adjacent block based on a difference in the pixel value between the current block and the adjacent block. A filtering unit 1020 selects pixels having the calculated direction and performs filtering on the selected pixels. A direction determination was described above and filtering will be described later in detail.

Hereinafter, pixel value calculation by filtering will be described in detail.

For filtering, information about the necessity of filtering and information about a filtering strength are determined. The filtering strength differs depending on a boundary strength called a Bs parameter. The Bs parameter differs depending on prediction modes of two blocks, a motion difference between the two blocks, and presence of encoded residuals of the two blocks.

| Condition | Bs |
|---|---|
| Any one of two blocks is in intra mode and any one of | 4 |
| the two blocks is located on a boundary of a macroblock | |
| Any one of two blocks is in intra mode | 3 |
| Any one of two blocks has a residual signal | 2 |
| MV >= one-sample interval and motion compensation is | 1 |
| performed using difference reference frames | |
| Others | 0 |

In Table 1, a determination is sequentially made in the order of top-down as to whether any one of the conditions is satisfied. When any one of the conditions is first satisfied, a value corresponding to the condition is determined to be a Bs parameter. For example, if the boundary of a block is the boundary of a macroblock and any one of the adjacent two blocks is encoded in intraprediction mode, the Bs parameter is 4.

If a block is not located on the boundary of a macroblock and any one of two blocks is in an intraprediction mode, the Bs parameter is 3. If any one of two blocks is in an interprediction mode and has a nonzero transform coefficient, the Bs parameter is 2. If any one of two blocks does not have a nonzero transform coefficient, a motion difference between the two blocks is equal to or greater than 1 pixel of luminance, and motion compensation is performed using other reference frames, the Bs parameter is 1. If any condition is not satisfied, the Bs parameter is 0. The Bs parameter of 0 indicates that there is no need for filtering.

After the Bs parameter is determined, pixels located on the boundary of a block are searched. In a filter that removes discontinuity, it is important to distinguish the actual discontinuity that expresses objects of an image from discontinuity caused by quantization of transform coefficients. In order to preserve quality of an image, the actual discontinuity should be filtered as little as possible. On the other hand, discontinuity caused by quantization should be filtered as much as possible.

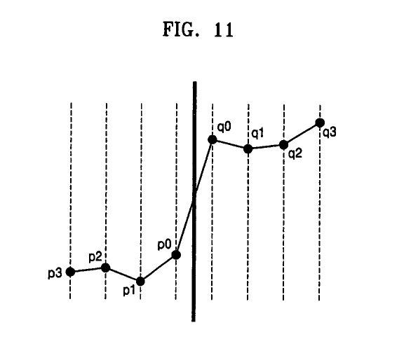

FIG. 11 shows a boundary portion between blocks.

Pixel values of a line having actual discontinuity as shown in FIG. 11 inside two adjacent blocks will be explained as an example. Since filtering is not performed when the Bs parameter is 0, the Bs parameter is not 0, and parameters α and β are used to determine whether to perform filtering on each pixel. These parameters have correlations with a quantization parameter (QP) and differ depending on local activity around a boundary. Selected pixels are filtered when conditions of following Equation 4 are satisfied.
|p₀−q₀|<α
|p₁−p₀|<β
|q₁−q₀|<β (4)

When two pixels that are closest to a boundary are less than α and p1, p0, q1, and q0 are less than β that is less than α, discontinuity around a boundary is determined to be caused by quantization. α and β are determined according to a table prescribed by H.264 AVC and differ depending on the QP.
Index_{A}=min(max(0, QP_{AV}+Offset_{A}), 51)
Index_{B}=min(max(0, QP_{AV}+Offset_{B}), 51) (5),
where Q_{AV} is an average of QPs of two adjacent blocks. By controlling an index within a range of a QP, i.e., [0, 51], using Equation 5, α and β are obtained. According to the table prescribed by H.264 AVC, when IndexA<16 or IndexB<16, both α and β are or one of α and β is 0, which means that filtering is not performed. This is because it is inefficient to perform filtering when the QP is very small.

Also, an offset value that controls α and β can be set by an encoder and its range is [−6, +6]. The amount of filtering can be controlled using the offset value. By controlling a property of a filter for removing discontinuity using a nonzero offset value, it is possible to improve the subjective quality of a decoded image.

For example, when a difference between the pixel values of adjacent blocks is small, the amount of filtering is reduced using a minus offset value. Thus, it is possible to efficiently preserve quality of high-resolution video contents in a small and fine area.

The parameters described above affect the actual filtering of pixels. Filtered pixels differ depending on the Bs parameter which is a characteristic of a block boundary, where when the Bs parameter is in a range of 1-3, except when the Bs parameter is 0, basic filtering operations with respect to luminance are performed as follows.
p₀=p₀+Δ
q₀=q₀+Δ (6)

Here, Δ is used to control the original pixel value and is calculated as follows.
Δ=min(max(−t_{c}, Δ₀),t_{c})
Δ₀=(4(q₀−p₀)+(p₁−q₁)+4)>>3
t_{c}=t_{c0}+((αₚ<β)?1:0)+((α_{q}<β)?1:0) (7)

Here, Δ is limited to the range of a threshold value tc, and when tc is calculated, a spatial activity condition used for determining the extent of filtering is investigated using β as follows.
αₚ=|p₂−p₀|<β
α_{q}=|q₂−q₀|<β (8)

If the above-described condition is satisfied using Equation 8, a pixel value is changed based on Equation 9 by performing filtering.
p₁=p₁+Δₚ₁
q₁=q₁+Δ_{q1}
Δₚ₁=(p₂+((p₀+q₁+1)>>1)−2p₁)>>1 (9)

Here, p0 and q0 are filtered with a weight of (1,4,4,−1)/8 using Equation 7, and their adjacent pixels p1 and p1 are filtered with a tap having very strong low pass features such as (1,0,5,0.5)/2 of Equation 9. Filtering of pixel values is applied using clipping ranges that differ depending on the Bs parameter. The clipping ranges are determined by a table composed of Bs and IndexA. tc0 of Equation 7 is determined according to the table and determines the amount of filtering applied to each boundary pixel value.

When the Bs parameter is 4, the amount of filtering is determined using a strong 4-tap and 5-tap filter-to-filter a boundary pixel and two internal pixels. The strong filter investigates a condition in which filtering is performed, using Equation 4, and again the condition of Equation 10. High filtering is only performed when these conditions are satisfied.
|p₀−q₀|<(α>>2)+2 (10)

Strong filtering is performed by reducing a difference between the pixel values of two adjacent pixels on a boundary. If the condition of Equation 10 is satisfied, pixel values p0, p1, p2, q0, q1, and q2 are calculated using Equation 11.
p₀=(p₂+2p₁+2p₀+2q₀+q₁+4)>>3
p₁=(p₂+p₁+p₀+q₀+2)>>2
p₂=(2p₃+3p₂+p₁+p₀+q₀+4)>>3 (11)

Here, q0, q, and q2 are calculated in the same manner as Equation 11.

A filter for removing H.264 AVC discontinuity, which is adaptively processed according to each parameter, causes complexity, but removes a blocking effect and improves subjective quality of an image.

As described above, according to the present invention, it is possible to remove the blocking effect and improve the image quality.

Meanwhile, embodiments of the present invention can also be implemented through computer-readable code in a medium, e.g., a computer-readable recording medium. The medium may be any device that can store/transfer data which can be thereafter read by a computer system. Examples of the medium include at least read-only memory (ROM), random-access memory (RAM), CD-ROMs, magnetic tapes, floppy disks, optical data storage devices, and carrier waves. The medium can also be distributed over network coupled computer systems so that the computer-readable code is stored and executed in a distributed fashion.

While the present invention has been particularly shown and described with reference to an exemplary embodiment thereof, it will be understood by those of ordinary skill in the art that various changes in form and details may be made therein without departing from the spirit and scope of the present invention as defined by the following claims.

1. A filtering method comprising:
determining direction on a boundary of a block of an image divided into blocks of a predetermined size, based on pixel distribution between adjacent blocks; and
filtering the blocks based on the determined direction.

2. The filtering method of claim 1, wherein in the filtering of the blocks is performed differently with respect to each of boundary pixels according to the direction of each of the boundary pixels in the blocks.

3. The filtering method of claim 1, wherein the direction comprises a gradient.

4. The filtering method of claim 1, wherein the block is square.

5. A filtering method which removes discontinuity on boundaries between blocks of a predetermined size in an image composed of the blocks, the filtering method comprising:
determining a direction of discontinuity on a boundary of a block based on a difference in pixel value between a pixel on the boundary of the block and a pixel on a boundary of an adjacent block of the block; and
filtering the block using pixels selected differently, based on the determined direction.

6. The filtering method of claim 5, wherein the adjacent block is located on the left side and upside from the block.

7. The filtering method of claim 5, wherein the blocks of the predetermined size are macroblocks.

8. The filtering method of claim 5, wherein the direction comprises one of a horizontal direction, a vertical direction, and a diagonal direction.

9. The filtering method of claim 8, wherein the diagonal direction comprises one of a direction from upper left to lower right and a direction from lower left to upper right.

10. The filtering method of claim 5, wherein determining the direction of discontinuity on a boundary of a block comprises:
calculating a sum of differences in pixel value between the pixel on the boundary of the block and the pixel on the boundary of the adjacent block, in the horizontal, the vertical, and the diagonal directions; and
determining a direction to be the direction of discontinuity on the boundary of the block.

11. The filtering method of claim 5, wherein a 4 pixels of adjacent block and 4 pixels of the block are selected according to the determined direction in the horizontal, the vertical, or the diagonal direction to filter the block.

12. The filtering method of claim 5, wherein the direction comprises a gradient.

13. The filtering method of claim 5, wherein the block is square.

14. A filter which removes the discontinuity on boundaries between blocks of a predetermined size in an image composed of the blocks, the filter comprising:
a direction determining unit determining the direction of discontinuity on a boundary of a block of an image divided into blocks of a predetermined size, based on the pixel distribution between adjacent blocks; and
a filtering unit filtering the blocks based on the determined direction.

15. The filter of claim 14, wherein the adjacent block is located to the left side and upside from the block.

16. The filter of claim 14, wherein the blocks of a predetermined size are macroblocks.

17. The filtering method of claim 14, wherein the direction comprises a gradient.

18. The filtering method of claim 14, wherein the block is square.

19. The filter of claim 14, wherein the direction comprises a horizontal direction, a vertical direction, and a diagonal direction.

20. The filter of claim 19, wherein the diagonal direction comprises a first direction from upper left to lower right or a second direction from lower left to upper right.

21. The filter of claim 14, wherein the direction determining unit calculates a sum of differences in pixel value between the pixel on the boundary of the block and the pixel on the boundary of the adjacent block, in the horizontal, the vertical, and the diagonal directions and determines the direction to be the direction of discontinuity on the boundary of the block.

22. The filter of claim 14, wherein the filtering unit selects 4 pixels of adjacent block and 4 pixels of the block to be filtered according to the determined direction in the horizontal, the vertical, or the diagonal direction to filter the block.

23. A medium comprising computer readable code implementing a filtering method comprising:
determining direction on a boundary of a block of an image divided into blocks of a predetermined size, based on pixel distribution between adjacent blocks; and
filtering the blocks based on the determined direction.

24. The medium of claim 23, wherein the direction comprises a gradient.

25. The medium of claim 23, wherein the block is square.
